(19) United States
(12) Patent Application Publication
(10) Pub. No.: US 2016/0039533 A1
(43) Pub. Date: Feb. 11, 2016

(54) ANTI-STATIC, PRESSURE-SENSITIVE ADHESIVE PATCH AND METHOD OF USE

(71) Applicant: Mary Haley, Dayton, OH (US)

(72) Inventor: Mary Haley, Dayton, OH (US)

(73) Assignee: Mary Haley, Dayton, OH (US)

(21) Appl. No.: 14/452,441

(22) Filed: Aug. 5, 2014

(51) Int. Cl. B64D 45/02

(52) U.S. Cl. CPC B64D 45/02

(57) ABSTRACT

The ready-to-use, anti-static, pressure-sensitive adhesive patch provides a means preventing and/or eliminating the accumulation of static electricity as it occurs in the course of everyday activities. The buildup may occur between a human and their clothing, or between two articles of clothing (known as static cling), or between clothing and other fabric. The buildup may also occur when a person slides onto and off a seat (to include an automobile seat when entering and exiting a vehicle). The patch will be comprised of a fibrous top side coupled with an adhesive bottom side, which delivers or exposes a pre-determined amount of anti-static agent. This patch can be customized with fragrance, additional additives, and can be of any shape or size. The patch can adhere to either the human body or to fabric.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A CD

Not Applicable.

REFERENCES CITED
U.S. Patent Documents

| | | | |
|---|---|---|---|
| 6,767,603 | September 1999 | Hurst, et al. | 428/36.1 |
| 6,562,428 | March 2000 | Ohrui | 428/40.1 |
| 5,991,922 | November 1999 | Banks | 002/69 |
| 5,726,143 | March 1998 | Petraia, et al. | 510/519 |
| 5,637,368 | June 1997 | Cadalbert, et al. | 428/40.1 |
| 5,495,633 | March 1996 | Speer | 15/104.94 |
| 5,378,405 | January 1995 | Gutman, et al. | 252/500 |
| 4,749,612 | June 1988 | Borkowski, et al. | 442/149 |
| 4,129,505 | December 1978 | Dasher, et al. | 252/8.91 |
| 2009/0317634 | December 2009 | Suh | 428/354 |
| 2008/0103084 | May 2008 | Banco, et al. | 510/516 |
| 2007/0082196 | April 2007 | Ali, et al. | 428/352 |
| 2006/0251892 | November 2006 | Husemann, et al. | 428/354 |
| 2006/0000107 | January 2006 | Wylie | 34/80 |
| 2003/0224962 | December 2003 | Fryc | 510/438 |
| 2003/0188450 | October 2003 | Ogden, et al. | 34/597 |

### FIELD OF THE INVENTION

The present invention relates, generally, to an anti-static, pressure-sensitive self-adhesive patch which provides delivery or exposure of an anti-static agent to the attire of a subject, and/or to the subject themselves, and/or to an item the subject is in contact with, in order to reduce or possibly eliminate the accumulation of static electricity and/or dissipate the static electricity as it occurs.

This invention pertains to the fields of art specific to the following:

U.S. Class: 002/69; 002/902; 424/448; 428/34.9, 428/40.1; 428/352; 428/354; 428/355R; and 428/359; 510/516; 510/519; 510/520; 510/438.

Int'l Class: B32B 7/12; B32B 33/00; CO9J 7/02; CO9J 133/06; CO9J 7/04

The present invention relates to the buildup of static electricity which normally accumulates through walking and other daily activities, especially when done on carpet, in cold and dry climates, and in environments conducive to static electricity build-up.

This invention improves the ability to perform daily activities without continuously building up static electricity, by reducing the ability for the accumulation of static electricity as it occurs. This reduction in the static electricity (or charge) further reduces the ability of charged clothing to cling to the body or other fabric, (also known as ‘static cling’), without the use of chemical sprays or continuous manual re-application. Finally, the reduction of charge reduces the potential for the occurrence of mild to moderate electric shock.

### BACKGROUND OF THE INVENTION

Static electricity build up occurs naturally when friction causes, builds, and transfers a charge in the course of everyday activities, including but not limited to: walking, sliding onto and off a seat, (including while entering and exiting an automobile), sitting, moving over carpet, and residing/working in cold and/or dry climates. This static electricity build up often creates an electric charge, which can result in static cling, as well as mild to moderate electric shock. This invention seeks to significantly reduce and possibly eliminate the build-up of static electricity as it would occur in the course of normal daily activities. This invention further seeks to reduce or eliminate the need to manually re-apply an anti-static agent several times a day, as well as reduce or eliminate the need to make the anti-static agent a permanent part of the article of clothing or upholstery. This invention seeks to provide a medium which is ready-to-use, and is easily applied and removed, while staying in place for extended periods of time. The invention permits a customizable size and shape of the pressure-sensitive adhesive patch. This invention permits a customizable fragrance and can be enhanced with additional additives. Finally, this invention contains and delivers on contact a pre-determined amount of anti-static agent based on the size and/or shape of the patch.

Prior-art has examined the means of reducing or eliminating static electricity for different purposes. A detailed description of the prior art follows.

U.S. Publication 2006/0251892 discloses an anti-static pressure-sensitive adhesive tape of multilayer construction, which comprises a support material with an electrically conducting primer and a self-adhesive material layer, a supporting material, an electrically-conducting primer and two self-adhesive material layers or a support material (FIGS. 1, 2, 3, Elements A, B, C, D; Claim 1; Paragraphs [0001]-[0008]). The primary utility of this prior art is particular to the computer industry and repositionable bonds.

U.S. Pat. No. 5,726,143 discloses an article for improving anti-static protection of clothing dried in a clothes dryer. The article includes a substrate, a layer comprising a first quaternary ammonium anti-static agent that has a first melting point, as well as a method for making the article. This prior art requires a clothing dryer for use of the item.

U.S. Pat. No. 5,637,368 discloses anti-static adhesive tapes and sheets, which comprise an adhesive layer and utilizes vanadium oxide to impart anti-static properties to the article which is designed to prevent the build-up of electric charges (claim 1; Column 10, Lines 50-55). This prior art is specific to technology fields, such as the electronics industry.

U.S. Pat. No. 5,378,405 discloses a conductive, polymeric, inherently tacky, solvent-insoluble, solvent-dispersible, elastomeric, pressure-sensitive adhesive for adhesive tapes and the like, which comprises microparticles having an average diameter of at least about 1 micrometer, said microparticles having an ionic conductive material present on said surface, and anti-static pressure-sensitive adhesive tapes made therefrom (claim 1, 2, 15-18; Column 4, Lines 40-68; Examples 2-6, Tables 3, 4). This prior art is specific to attaching surface-mount components at points on printed circuit boards, and for masking printed circuit boards prior to wave soldering.

U.S. Pat. No. 4,749,612 discloses colored, anti-static adhesive tape, which is characterized in that it encompasses (a) a fabric base (b) which is coated with carbon black in a binder, (c) the coating assuming the structure of the fabric base, (d) and printed with a non-conductive thixotropic ink, (e) the ink being present in the recesses of the fabric base, as well as (f) an adhesive on the rear face (FIG. 1, Elements 7, 4, 3, 1, 2, 5, 6; Claim 1, Column 1, Line 4 to Column 2, Line 2). This prior art is to ensure that the tape can be altered in color, and specifically, to not draw attention to the color.

US Publication No. 4,129,505 discloses an anti-static spray comprising an ethanol solution of quaternary ammonium fabric softener in combination with ammonium acetate. The spray is particularly adapted for application to clothing otherwise ready to wear. This prior art relates to an anti-static agent which must be sprayed on.

U.S. Publication No. 2009/0317634 discloses an anti-static pressure-sensitive or adhesive tape, which comprises an anti-static tape, in which, upon anti-static treatment using a conductive polymer on the exposed surface of the tape opposite the surface having an adhesive (FIG. 1, 2, 3, Elements 10-17; Claim 22; Paragraphs [0008]-[0018]). This prior art is specific to increase the contact angle with respect to water so as to easily remove water drops in a water-using process and antismudge performance able to prevent the generation of smudges due to oil or to easily remove generated smudges may be imparted together, unlike conventional protective films.

U.S. Publication No. 2007/0082196 discloses an adhesive tape with an anti-static release coating, which comprises an anti-static additive made from a reaction product of from about 1 to 30 parts hydrophilic monomer, from about 5 to 40 parts ionic monomer, and from about 20 to 80 parts hydrophobic monomer (FIG. 1, Elements 12, 22, 14, 18, 20; Claims 1, 15; Paragraphs [0012]-[0018]). This prior art applies to the static electricity generated by unwinding a roll of adhesive tape.

U.S. Pat. No. 6,562,428 discloses an anti-static adhesive sheet, which comprises a plastic substrate film (e.g. PET film), an anti-static layer which is formed on either side thereof and which comprises a quaternary ammonium salt, preferably a high molecular type quaternary ammonium salt, and an adhesive agent layer (claim 1; Column 2, Line 64 to Column 3, Line 64). This prior art is provided to suppress bleed out of an anti-static agent while preserving the transparency for purposes such as in articles required for transparency for a cover sheet.

U.S. Publication No. 2006/0000107 discloses a patch for the elimination of static cling, which comprises one or more flexible sheets, wherein the main body defines a plurality of slits; and includes a static eliminating patch portion of the main body (FIG. 1; Claims 2, 3). This prior art requires a dryer and is specified to be a dryer device.

U.S. Pat. No. 5,495,633 discloses a device for eliminating static cling, which comprises a device to be carried in a woman's purse and when cling occurs, the user rubs the impregnated material against the affected area to eliminate cling (FIG. 1-3, Elements 32, 12; Claim 1). This prior art requires dispensing the anti-static solution via a frame.

U.S. Publication No. 2003/0224962 discloses a sheet of material for the elimination of static cling, which comprises a combination of moisture and the fabric softener in the dry sheet and which helps to simultaneously remove wrinkles from the clothes and prevent static cling (Paragraph [0002]). This prior art required the use of a rotating hot-air dryer.

U.S. Publication 2003/0188450 discloses a fabric softening system comprising a liquid fabric softening composition which is carried in liquid form within a substrate, which is introduced into a rotary clothes dryer with laundered, wet clothing where the softening composition is released into the fabric of the articles of clothing to impart both softening and anti-static properties. This prior art required application to clothing while wet and through a rotary clothes dryer.

U.S. Publication No. 2008/0103084 discloses a multifunctional laundry sheet, which comprises and combines the benefits of a color catcher, a fabric softener, and static cling eliminator (Abstract; Claim 11). This prior art requires the use of a washing machine and is an integral part of the clothes washing process.

U.S. Pat. No. 6,767,603 discloses an anti-static article of workwear clothing, which comprises a plurality of components (17,18) incorporating electrically conductive fibres (21), and an electrically conductive member (20) bridging the junction between adjacent components (Column 2, Line 27 to Column 4, Line 30). This prior art relates to anti-static workwear for use in the micro-electronics industry.

U.S. Pat. No. 5,991,922 discloses a monitored static electricity dissipation garment, which comprises a voltmeter which is displayed to the wearer of the garment the amount of static electricity that is on a human's body at any given instant (FIG. 1). This prior art requires the static-electricity dissipation to occur within the garment and register the amount of static electricity is on the wearer of the garment.

The prior art primarily requires one of the following: (1) anti-static agent being dispensed through the laundering process, (2) the anti-static agent being an un-severable part of the garment, (3) the anti-static agent being reapplied throughout the day. Some of the prior art is industry specific, and does not attempt to incorporate everyday activities. Finally, most of the prior art reduces static electricity before or after it occurs, but not during the act of creating the static electricity in the course of everyday activities.

It would be desirable to have an anti-static agent which reduces or possibly eliminates static electricity as it occurs in the course of normal daily activities. It would also be desirable that the anti-static agent be continuously dispensed without involving a manual reapplication. The anti-static agent should be applied continuously without being a permanent part of the fabric. The anti-static medium should be ready-to-use, whereby it is easily applied and removed, while staying in place for extended periods of time. Finally, the uses should be flexible to incorporate everyday activities, and customizable to be aesthetically appealing by sight and scent. It is further desirable that the amount of anti-static agent be pre-determined based on the shape and size of the medium.

Thus, there is a need for a patch which can aggregately combine the benefits of continuously dispensing a pre-determined amount of anti-static agent in a ready-to-use medium which can be easily applied and removed, stays in place for extended periods of time, and can incorporate everyday activities. There is further a need for said patch to be customizable in size, shape, fragrance, and additives.

### OBJECTS OF THE INVENTION

It is an object of this invention to provide a patch which reduces or possibly eliminates static electricity as it occurs in the course of normal daily activities.

It is an object of this invention to provide a patch which would have an anti-static agent which is continuously delivered without involving a manual reapplication.

It is another object of this invention that the patch would deliver the anti-static agent continuously without being a permanent part of the clothing or upholstery.

It is further an object of this invention that the patch would be ready-to-use, enabling easy application and removal, while staying in place for extended periods of time.

It is another object of the invention that the patch would be self-adhesive.

It is further object of this invention that the uses of the patch would be flexible to incorporate everyday activities, and customizable to be aesthetically appealing.

It is another the object of this invention that this patch would contain and deliver on contact a pre-determined amount of anti-static agent based on the size and/or shape of the patch.

### SUMMARY OF THE INVENTION

A ready-to-use, anti-static, pressure-sensitive adhesive patch and method of use are disclosed.

In order to overcome static electricity build-up in the course of everyday activities, this invention seeks to provide a medium for release of anti-static agent in the form of a ready-to-use, pressure-sensitive, self-adhesive patch.

In one preferred embodiment, a patch will be comprised of a fibrous top side coupled with an adhesive bottom side, which delivers or exposes a pre-determined amount of anti-static agent. This patch can be customized with fragrance, additional additives, and can be of any shape or size. The patch can adhere to either the human body or to fabric.

The patch may be manufactured in a variety of ways. It may be manufactured by (but not limited to) dipping the patch into a bath of fabric softening additives, spraying one side of a pretreated patch with fabric softening additives, or impregnating the patch with anti-static agent.

Other advantages and features of the disclosed will be described in greater detail below.

### DETAILED DESCRIPTION OF THE PREFERRED EMBODIMENTS

The ready-to-use, anti-static, pressure-sensitive adhesive patch provides a means of preventing and/or eliminating static electricity build-up as it occurs through the course of everyday activities. The buildup may occur between a human and their clothing, or between two articles of clothing (known as static cling), or between clothing and other fabric. The buildup may also occur when a person slides onto and off a seat (to include an automobile seat when entering and exiting a vehicle). The buildup may also occur through a myriad of everyday activities.

The patch will be comprised of a fibrous top side coupled with an adhesive bottom side, which delivers or exposes a pre-determined amount of anti-static agent. This piece can be customized with fragrance, fabric softener, and can be of any shape or size.

A patch which may adhere to a person, their clothing, or a fabric article with which a person is in contract with to prevent or inhibit the accumulation of static electricity.

In a refinement, the patch can be adhered to an article of clothing to prevent the undesirable appearance of static cling, especially in women's apparel, while simultaneously reducing the potential for mild to moderate electric shock.

In a second refinement, the patch can be adhered to the human body, preferably the leg or thigh, to eliminate static cling while simultaneously reducing the potential for mild to moderate electric shock.

In a third refinement, the patch may be used to incorporate a fragrance to the fabric it comes into contact with, or into the environment. If the patch is adhered to or near the skin, natural body heat may amplify the fragrance. An attribute of disclosed patch is that it provides a means for transferring fragrance continuously as well as anti-static agent.

In a fourth refinement, the patch can be adhered to an seat, such as an office seat or an automobile seat, which is susceptible to friction from sliding onto and off from said seat. This friction often leads to a buildup of static electricity, and transference of the charge to the person sliding onto and off from said seat, yielding the undesirable effect of static cling and potential for mild to moderate electric shock. The placement of the patch is ideally on a discrete area of the seat to prevent or eliminate the buildup of the charge.

Therefore, one advantage is that the disclosed patch addresses the accumulation of static electricity as it occurs, and inhibits or prevents the static build-up resulting in static cling and/or mild to moderate electric shock.

Another advantage of some embodiments enclosed herein is to eliminate the inconvenience of using an anti-static product which must be manually reapplied throughout the course of daily activities. Therefore, another advantage is the elimination of carrying or storing such an agent.

The patch can be of any shape or size, whereby there is an anti-static agent present with an adhesive in a ready-to-use form.

The anti-static agent can be comprised of any single or myriad of anti-static agents which prevent or eliminate static electricity buildup or static cling, to include fabric softeners.

What is claimed:

1. A ready-to-use, anti-static, pressure-sensitive, self-adhesive patch comprising of:
a. a fibrous top side
b. an anti-static agent
c. an adhesive bottom side
wherein the above components deliver or expose said anti-static agent, and said components can be formed into an patch of any shape or size, and can adhere to either the human body or to fabric.

2. The patch according to claim 1 further comprising sufficient anti-static agent so as to impart anti-static properties to that which it comes into contact with.

3. The patch according to claim 2 further comprising anti-static agent which is also a fabric softener.

4. The patch according to claim 3 further comprising fragrance.

5. The patch of claim 1 wherein said adhesive side is a pressure-sensitive adhesive.

6. The patch of claim 1 wherein said anti-static agent is pre-determined based on shape and size.

7. The patch of claim 1 wherein said patch is ready to use, requiring no extraneous preparation of the patch.

8. A method of using a patch of claim 1 comprising adherence to the human body.

9. A method of using a patch of claim 1 comprising adherence to the fabric or upholstery.

10. A method of using a patch of claim 1 comprising adherence to the articles of clothing.

11. The patch of claim 2 wherein said adhesive side is a pressure-sensitive adhesive.

12. The patch of claim 2 wherein said anti-static agent is pre-determined based on shape and size.

13. The patch of claim 2 wherein said patch is ready to use, requiring no extraneous preparation of the patch.

14. A method of using a patch of claim 2 comprising adherence to the human body.

15. A method of using a patch of claim 2 comprising adherence to the fabric or upholstery.

16. A method of using a patch of claim 2 comprising adherence to the articles of clothing.

17. The patch of claim 3 wherein said adhesive side is a pressure-sensitive adhesive.

18. The patch of claim 3 wherein said anti-static agent is pre-determined based on shape and size.

19. The patch of claim 3 wherein said patch is ready to use, requiring no extraneous preparation of the patch.

20. A method of using a patch of claim 3 comprising adherence to the human body.

21. A method of using a patch of claim 3 comprising adherence to the fabric or upholstery.

22. A method of using a patch of claim 3 comprising adherence to the articles of clothing.

23. The patch of claim 4 wherein said adhesive side is a pressure-sensitive adhesive.

24. The patch of claim 4 wherein said anti-static agent is pre-determined based on shape and size.

25. The patch of claim 4 wherein said patch is ready to use, requiring no extraneous preparation of the patch.

26. A method of using a patch of claim 4 comprising adherence to the human body.

27. A method of using a patch of claim 4 comprising adherence to the fabric or upholstery.

28. A method of using a patch of claim 4 comprising adherence to the articles of clothing.
